(19) United States
(12) Patent Application Publication
(10) Pub. No.: US 2007/0028682 A1
(43) Pub. Date: Feb. 8, 2007

(54) System for measuring fluid level using acoustic impedance matching

(76) Inventors: Geon Sagong, Pusan (KR); Chul Han Kim, Pusan (KR); Jun Hee Lee, Pusan (KR)

Correspondence Address: NATHAN N KALLMAN, 20900 SARAHILLS DRIVE, SARATOGA, CA, 95070, US

(21) Appl. No.: 11/196,361

(22) Filed: Aug. 4, 2005

(51) Int. Cl. G01F 23/296; H01H 29/00; H01H 35/18; H01H 57/00

(52) U.S. Cl. 73/290 V; 200/61.2; 200/61.1

(57) ABSTRACT

A system for measuring a fluid level using an acoustic impedance matching is disclosed, which is capable of accurately measuring a fluid level using a flat panel medium, in particular, polyethylene, with the flat panel medium being impedance-matched with an object medium. The flat panel medium having the same acoustic impedance as the object medium is used, and the limit switch is directly connected through the flat panel medium, so that the angle coincidence problems are resolved. Since the sizes of signals are high, the construction of the electronic circuit is simplified, and the fabrication process is easy. The price of the system is low. Since polyethylene is used as the flat panel medium, the impedance matching with the object medium is easily achieved. Therefore, the present invention may be well adapted to measuring the fluid level.

### BACKGROUND OF THE INVENTION

1. Field of the Invention

The present invention relates to a system for measuring a fluid level using an acoustic impedance matching, which is capable of accurately measuring a fluid level using a flat panel medium, in particular, using polyethylene, with the flat panel medium being impedance-matched with an object medium.

2. Description of the Background Art Generally, a limit switch is a level sensor, which is capable of recognizing a liquid surface of fluid like oil or water in a tank. The liquid surface limit switch has been used to recognize a flowing state or storing state of liquid or dusts in a measuring control meter and pipe or container of a large size hopper including a small-sized water reserving tank or to recognize a liquid surface of a bulk material.

The liquid surface limit switch is classified into a mechanical type and an electric type. The mechanical type generally uses a float, and the electric type can be classified into an electric resistance type which uses a variation in electric resistance, a static power capacity type which uses a difference of dielectric constant of a material, and a ultrasonic wave type which uses a size difference of the ultrasonic waves measured in the air and the water.

The ultrasonic wave type limit switch has a disadvantage in that the dielectric constant and density of a piezoelectricity ceramic are too high, and an acoustic matching is impossible in the case that the medium is air or liquid. In order to resolve the above problem, a matching layer is provided. However, in this case, the output decreases due to an insertion loss, so that higher output power is needed. Since multiple layer matching materials are combined, a fabrication procedure is so complicated.

In addition, since a vertical direction resonant frequency of PZT ceramic, which is used as resonator, is too high, the frequency increases. Since the matching of acoustic impedance is not good, the signal decreases, and electronic circuit is complicated. Furthermore, it is needed to coincide the angles of a transmitter and a receiver, and the price is too high.

### SUMMARY OF THE INVENTION

Accordingly, it is an object of the present invention to overcome the above-described problems encountered in the conventional art.

It is another object of the present invention to provide a system for measuring a fluid level using a simple acoustic impedance matching in which an angle matching is easy since a limit switch is directly connected through a flat panel medium by using a flat panel medium having the same acoustic impedance as an object medium.

It is further another object of the present invention to provide a system for measuring a fluid level using an acoustic impedance matching which has been generally used for measuring a fluid level measuring by achieving an impedance matching with an object medium in such a manner that polyethylene is used as flat panel medium.

To achieve the above objects, there is provided a system for measuring a fluid level using an acoustic impedance matching with an object medium, comprising a limit switch which includes a flat panel medium which is formed in a longitudinal direction and is designed to have an acoustic impedance matching with an object medium, a piezoelectricity ceramic panel formed at both ends of an upper surface of the flat panel medium, and an electrode formed on an upper surface of the piezoelectricity ceramic panel, wherein a driving unit and a receiving unit are formed at both ends of an upper surface of the flat panel medium; a signal input unit for inputting an alternating current (AC) into the driving unit; a signal measuring unit for measuring a signal inputted into the receiving unit as the signal inputted from the signal input unit is inputted into the driving unit and passes through the object medium; and an oscillation circuit which returns the signal outputted from the receiving unit to the side of the driving unit.

The flat panel medium is formed of polyethylene.

In addition, the flat panel medium having the same acoustic impedance as the object medium is used, and the limit switch is directly connected through the flat panel medium, so that the angle coincidence problems are resolved. Since the sizes of signals are high, the construction of the electronic circuit is simplified, and the fabrication process is easy. The price of the system is low. Since polyethylene is used as the flat panel medium, the impedance matching with the object medium is easily achieved. Therefore, the present invention may be well adapted to measuring the fluid level.

### BRIEF DESCRIPTION OF THE DRAWINGS

The present invention will become better understood with reference to the accompanying drawings which are given only by way of illustration and thus are not limitative of the present invention, wherein;

FIG. 1 is a cross sectional view illustrating a limit switch of a system for measuring a fluid level using an acoustic impedance matching according to the present invention;

FIG. 2 is a view illustrating a vibration pattern of a limit switch in the air according to the present invention;

FIG. 3 is a view illustrating a vibration pattern of a limit switch in the water according to the present invention;

FIG. 4 is a block diagram of an oscillation circuit according to the present invention;

FIG. 5 is a circuit diagram of a hysteresis comparator of an oscillator circuit according to the present invention;

FIG. 6 is a view illustrating an output signal in the air according to the present invention;

FIG. 7 is a view of a waveform when a limit switch is in the water according to the present invention, of which (a) is 1[V/div], and (b) is 200[mV/div];

FIG. 8 is a size graph of a limit switch measured in the air and in the water according to the present invention;

FIG. 9 is a phase graph of a limit switch measured in the air according to the present invention;

FIG. 10 is a view illustrating a gain characteristic of a state variable filter of which (a) is a gain, and (b) is a phase according to the present invention;

FIG. 11 is a view illustrating a gain characteristic of an oscillation circuit (gain of gain X band pass filter of limit switch itself) according to the present invention; and

FIG. 12 is a view illustrating a waveform in the air (a) and in the water (b) based on a self-oscillation of a limit switch according to the present invention.

### DETAILED DESCRIPTION OF THE PREFERRED EMBODIMENTS

The preferred embodiments of the present invention will be described with reference to the accompanying drawings.

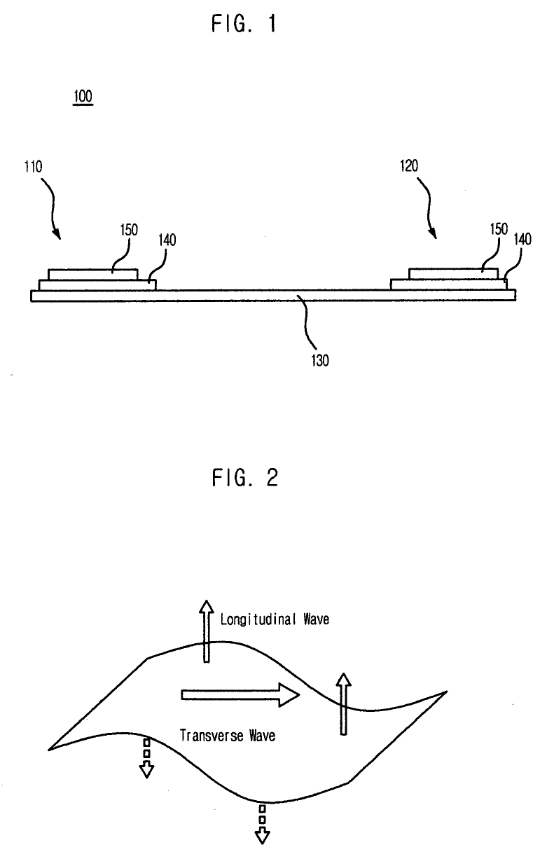

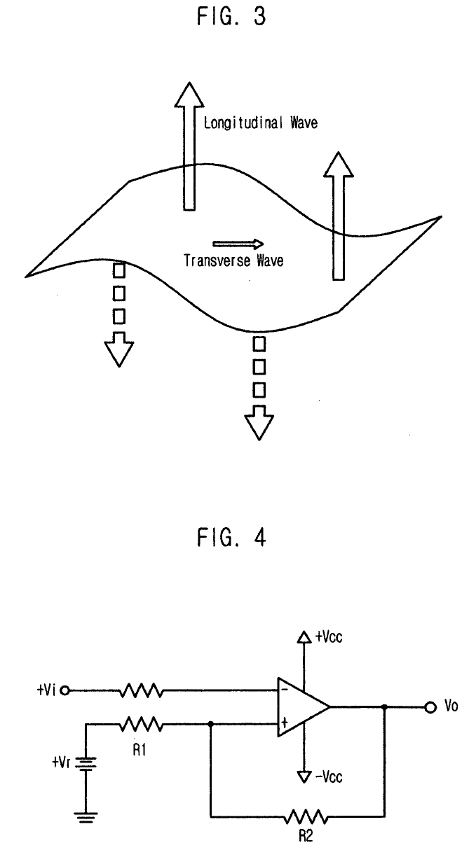

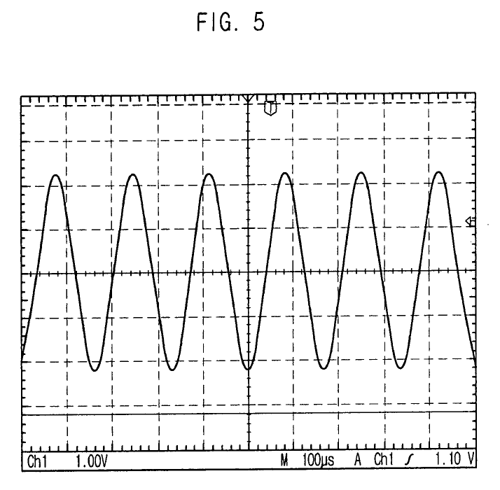

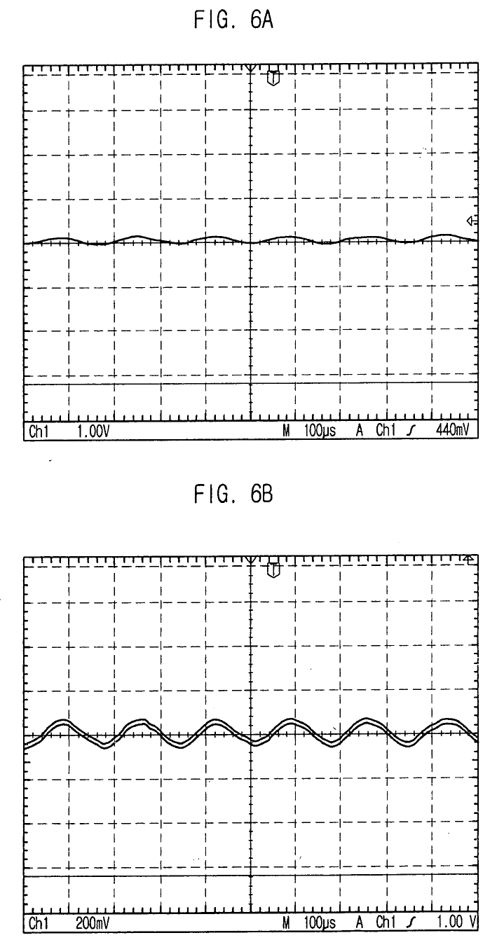

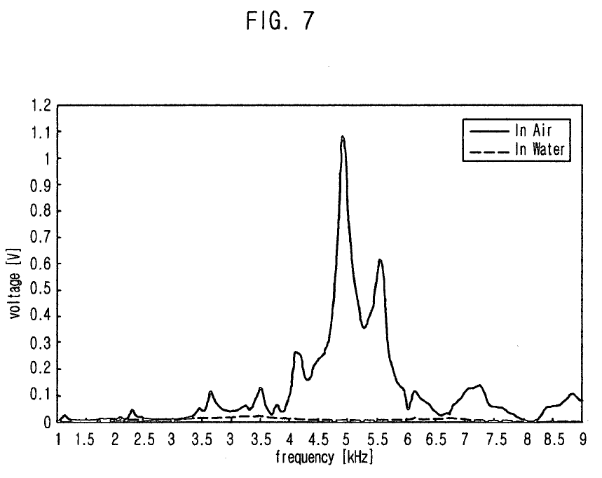

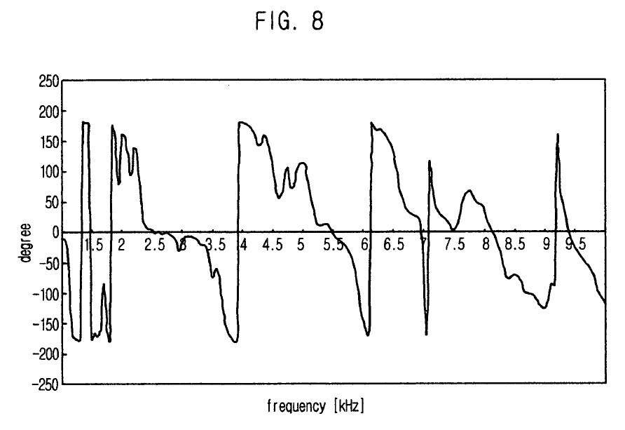

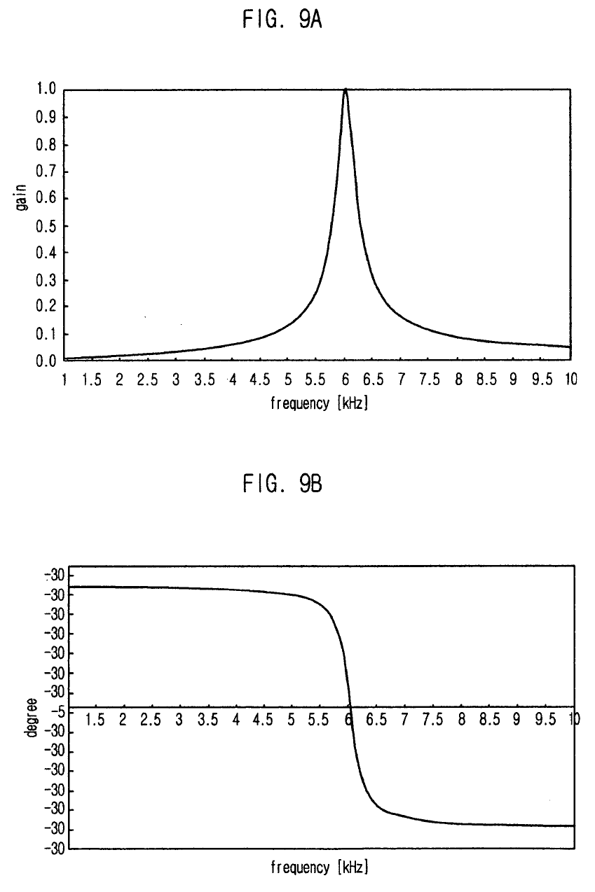

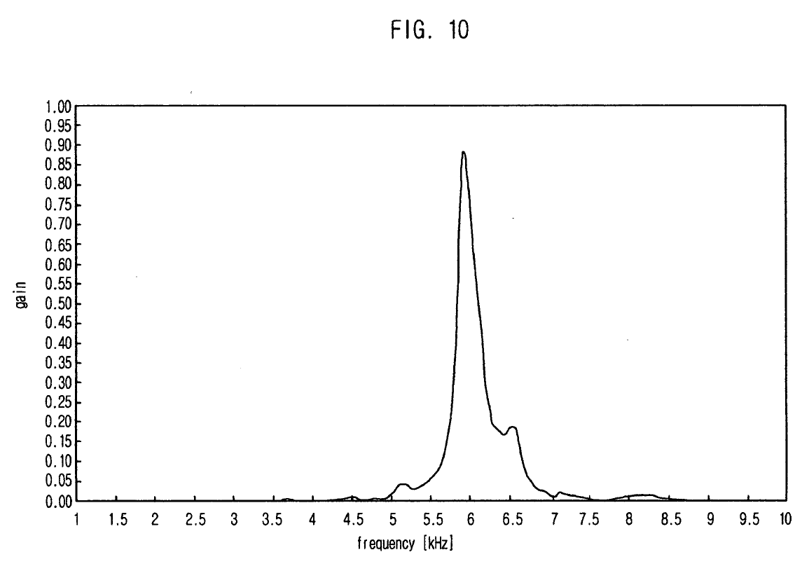

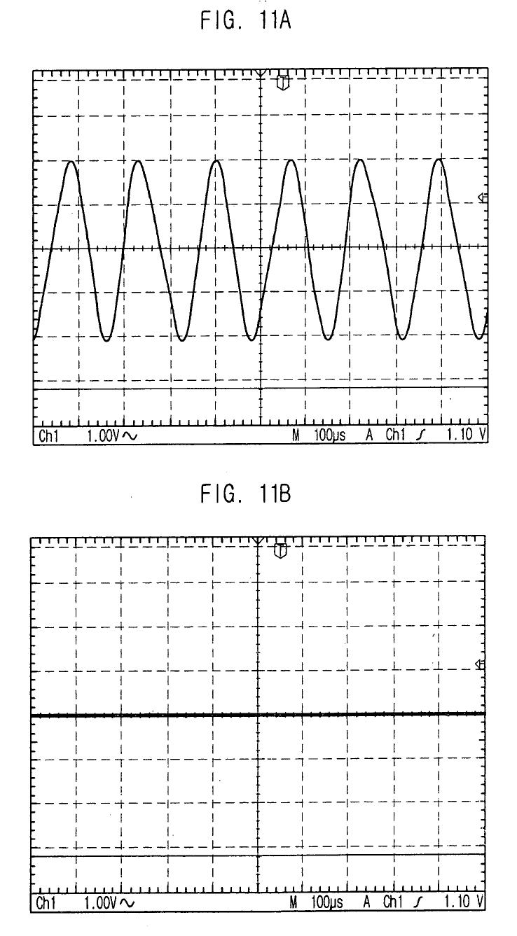

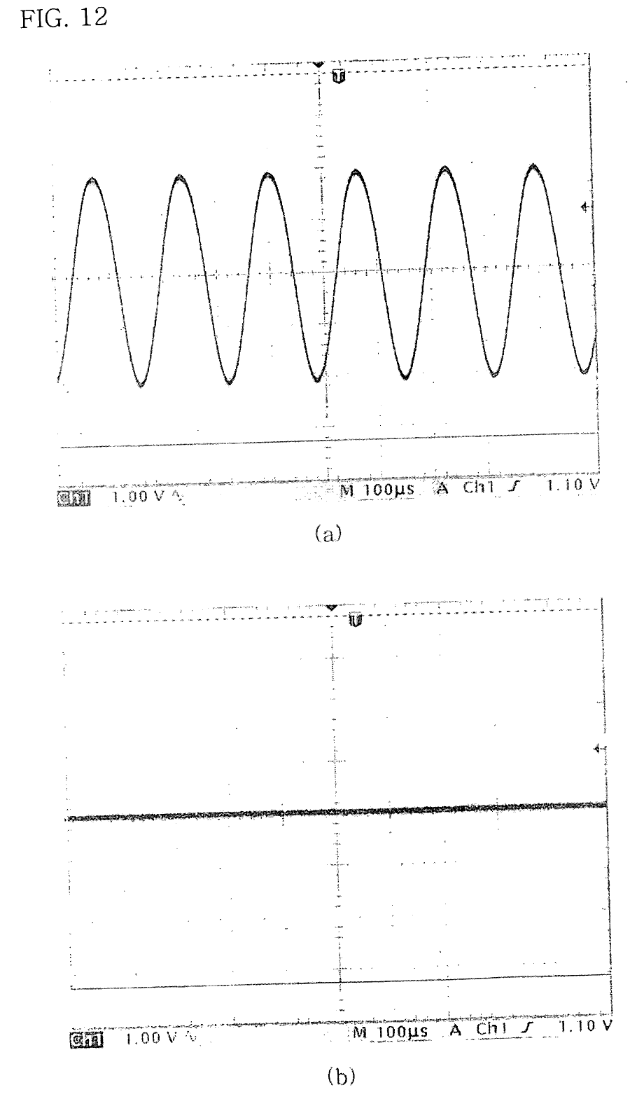

FIG. 1 is a cross sectional view illustrating a limit switch of a system for measuring a fluid level using an acoustic impedance matching according to the present invention, FIG. 2 is a view illustrating a vibration pattern of a limit switch in the air according to the present invention, FIG. 3 is a view illustrating a vibration pattern of a limit switch in the water according to the present invention, FIG. 4 is a block diagram of an oscillation circuit according to the present invention, FIG. 5 is a circuit diagram of a hysteresis comparator of an oscillator circuit according to the present invention, FIG. 6 is a view illustrating an output signal in the air according to the present invention, FIG. 7 is a view of a waveform when a limit switch is in the water according to the present invention, of which (a) is 1[V/div], and (b) is 200[mV/div], FIG. 8 is a size graph of a limit switch measured in the air and in the water according to the present invention, FIG. 9 is a phase graph of a limit switch measured in the air according to the present invention, FIG. 10 is a view illustrating a gain characteristic of a state variable filter of which (a) is a gain, and (b) is a phase according to the present invention, FIG. 11 is a view illustrating a gain characteristic of an oscillation circuit (gain of gain X band pass filter of limit switch itself) according to the present invention, and FIG. 12 is a view illustrating a waveform in the air (a) and in the water (b) based on a self-oscillation of a limit switch according to the present invention.

As shown therein, the system for measuring a fluid level using an acoustic impedance matching according to the present invention includes a limit switch, a signal input unit, a signal measuring unit, and an oscillation circuit.

First, the limit switch 100 will be described.

The limit switch 100 includes a flat panel medium 130, which is formed in a longitudinal direction and is matched with an object medium, with an acoustic impedance matching between the object medium and the flat panel medium 130, a piezoelectricity ceramic panel 140 formed of a driving unit 110 and a receiving unit 120 at both ends of an upper surface of the flat panel medium 130, and an electrode 150 formed at an upper surface of the piezoelectricity ceramic plate 140.

In the piezoelectricity ceramic panel 140 used at the limit switch 100, an electrode 150 is formed at both sides of the piezoelectricity ceramic panel 140 being opposite in order to polarize in the direction of thickness. Here, as a function of the electrode 150, a metallic electrode 150 formed of silver, etc. operates on an upper surface of the piezoelectricity ceramic panel 140, and the flat panel emdium1 30 operates on a lower surface. An oil paint, etc. is coated on a surface of the limit switch 100 for insulation.

The flat panel 130 is preferably formed of polyethylene. Here, the polyethylene (1.6[10⁶Ray1]) is a vibration propagation medium and has an acoustic impedance similar with water having (1.48[10⁶Ray1]), and the object medium is directly contacted with the limit switch 100. Namely, since the limit switch 100 is directly connected by a flat panel, the problems with respect to the acoustic impedance matching are resolved.

Since the limit switch 100 is attached with a flat panel medium of which one side is not extended or contracted by an electric field, the limit switch 100 oscillates in a vertical direction. If the voltage applied is an alternating current (AC), the vertical oscillation is repeatedly performed.

The resonant frequency of the limit switch 100 is determined depending on a piezoelectricity ceramic panel and a material and shape of a flat panel medium. Assuming the limit switch 100 operates as one oscillator, the resonant frequency fᵣ can be expressed as the following Equation 1, assuming that equivalent diameter is a, equivalent thickness is h, equivalent Young ratio is Y, equivalent density is p, and equivalent Poisson ratio is σ.

$${f}_{r} = \frac{{α}_{m}^{2} h}{4 \sqrt{3} π {a}^{2}} \frac{Y}{ρ ( 1 - {σ}^{2} )} \qquad [ Equation 1 ]$$

where αₘ is m-th reference constant.

Namely, the resonant frequency is in inverse proportion to the second power of the diameter and is in proportion to the thickness. Therefore, it is needed to increase the diameter and decrease the thickness in order to decrease the resonant frequency, and it is needed to decrease the diameter and to increase the thickness in order to increase the frequency.

The acoustic theory and characteristic acoustic impedance will be described as follows.

Generally, the ratio of the acoustic pressure with respect to particle speed in the medium represents a specific acoustic impedance \vec{z} and can be expressed as the following Equation 2.

$${z}^{->} = \frac{{p}^{->}}{\overline{u}} . \qquad [ Equation 2 ]$$

In particular, assuming that incident wave is plane wave, the above ratio can be expressed as the following Equation 3.
\vec{z}=±ρₒc [Equation 3]

Here, ρₒ represents an equivalent density of a medium, and c represents a speed of acoustic wave.

In the above Equation 3, symbols are determined depending on a propagation direction of acoustic wave. Here, the second power ρ_{oc} of the same has more important acoustic meaning rather than the values of ρₒ or c of the mediums. Here, the value ρ_{oc} represents a characteristic impedance of the medium.

The impedance of the medium is real number with respect to the forwarding plane wave, but is not real number with respect to sine waves. Generally, \vec{z} is complex number and may be expressed as follows.
\vec{z}=r+jx [Equation 4]

Here, r represents a specific acoustic resistance of sound with respect to specific acoustic wave, and x represents a specific acoustic reactance component. The characteristic impedance of medium with respect to acoustic waves is similar with wave impedance \sqrt{μ/∈} of dielectric medium with respect to electromagnetic waves and characteristic impedance Zo of transmission line.

When the forwarding acoustic wave meets another medium in one medium, reflected waves and transmitted waves are generated. The ratios of acoustic pressure and amplitudes between reflected waves and transmitted waves with respect to reflected waves are depend on characteristic acoustic impedance, the speed of the acoustic waves at two mediums, and the angle between the incident wave and interfaces. Here, the characteristic acoustic impedance of fluid of which incident waves and reflected waves forward is r_{1=ρ}₁. Here, ρ₁ represents equivalent density of fluid, and c₁ represents the speed of sound in fluid. In addition, the characteristic acoustic impedance of fluid in which transmitted waves forward is r_{2=ρ}_{2c2}.

Therefore, according to the acoustic characteristic of the limit switch 100, the piezoelectricity ceramic panel 140 is attached at both ends of the polyethylene flat panel medium 130, and the electrode 150 is formed on the upper surface of the same. Two limit switches 100 are provided at both ends of the flat panel medium 130, with the two limit switches respectively operating as a driving unit 110 (driving side limit switch 100) and a receiving unit 120 (receiving side limit switch 100).

When the AC is applied to the driving unit 110, the limit switch 100 vibrates in the vertical direction, and the vibrations are propagated in horizontal waves through the flat panel medium 130, and the vibration signals are converted into electrical signals at the receiving unit 120.

The vibration patterns of the limit switch 100 in the air are shown in FIG. 2. In this case, since the acoustic waves transmitting the air are less due to the acoustic impedance difference between the polyethylene flat panel medium 130 and the air, almost the vibration energy forwards along the flat panels, so that the electric signals generated at the receiving unit 120 increases.

However, as shown in FIG. 3, when the limit switch 100 is provided in the water, since the characteristic acoustic impedance of the flat panel and the characteristic acoustic impedance of water are similar, the impedance matching is enhanced, so that almost acoustic waves transmit water, and the vibration widths propagated to the receiving unit 120 decrease.

Next, the signal input unit is provided to input AC signals to the driving unit 110 and inputs sine waves using a known function generator/frequency counter.

The signals inputted into the driving unit 110 by the signal input unit pass through an object medium (air or fluid) and is inputted into the receiving unit 120. Here, a signal measuring unit measures the signals inputted from the receiving unit 120.

The signal measuring unit is designed to measure the output signal at the 10 resonant frequency of the limit switch 100 by applying sine wave input signals in order to check the amplitude and phase characteristic based on the frequencies. Tektronix TDS3014 digital oscilloscope has been conventionally used in order to measure the output signals. In addition, the Lock-In amplifier has been generally used in order to measure the amplitude and phase characteristic based on frequencies.

Next, the oscillation circuit is adapted to return the signals outputted at the side of the receiving unit 120 to the driving unit 110. Here, a self-oscillation circuit is formed using a band pass filter and an inverting amplifier without using external oscillator. Here, the band pass filter has been adapted in order to prevent the oscillation at the frequency except for the resonant frequency in the air. Since the limit switch 100 has a −180° phase difference near the resonant frequency. The input and output are adjusted to have the same phase using the inverting amplifier in order to meet the oscillation condition.

Here, the KHN state variation filter has been used as the band pas filter. The state variable filter may be formed of inverting and non-inverting circuits and has three outputs of low band pass, high band pass, and bandwidth pass.

In the case that the level of fluid is chattered at the interface of the limit switch 100, certain noises may occur due to the chattering. Therefore, the chattering problem is decreased by setting high threshold voltage and low threshold voltage using a hysteresis circuit. In the hysteresis circuit, part of the output is fed to the non-inverting terminal. FIG. 5 is a view illustrating a hysteresis comparator.

In the oscillation circuit, since the resonant frequencies of the limit switch 100 are not same, and it is impossible to attach to the flat panel with the same conditions, each limit switch 100 has different resonant frequencies. In the case that external oscillator is used, it is needed to manually adjust the oscillation frequencies with respect to each limit switch 100.

The output signal measured by the resonant frequency will be described.

The output signals in the air and water are measured at the resonant frequencies of the limit switch 100 by applying a sine wave input signal of ±5[Vₚ₋ₚ].

FIG. 6 is a view illustrating a waveform by measuring the output signal in the air using Tektronix TDS3014 digital oscilloscope 1[V/div]. Here, the output signal was a sine wave having an amplitude of ±2.2[Vₚ₋ₚ], which represents the decrease by 44[%] as compared to the input signal. The above result is obtained since part of the vibration energy is lost because perfect impedance matching did not occur at the interface between the limit switch 100 and the flat panel medium 130.

FIG. 7A is a view illustrating the waveform at 1[V/div] when the limit switch 100 is in the water, and FIG. 7B is a view illustrating the waveform when measured at 200[mV/div]. As shown therein, the output signal is largely decreased to about ±60[mV] due to the impedance matching between water and polyethylene flat panel medium 130. The output signal is 2.7[%] in the air and is 1.2[%] as compared to the input signal.

Next, the amplitude and phase characteristics based on the frequencies will be described.

The reference input signal is a sine wave of 2[Vrms], and the size and phase of the output signal are measured in the air and in the water within a frequency range of 1˜10[kHz].

FIG. 8 is a size graph of the limit switch 00 measured in the air and the water according to the present invention. As shown therein, the maximum output is obtained at 5.9[kHz] in the air, and the bandwidth is 180, and Q is 32.8. The amplitude is largely decreased in the water as compared to in the air.

FIG. 9 is a phase graph of the limit switch 100 measured in the air according to the present invention. As shown therein, the phase difference of about −180° is shown at 6.05[kHz] near the resonant frequency, which occurs because the maximum amplitude is generated at the point in which the vibration of the flat panel becomes semi-wavelength. The phase at the above frequency is made 0 using an electronic circuit, so that it is possible to achieve a self-oscillation without using external oscillator.

The oscillation characteristic of the limit switch 100 will be described.

The self-oscillation circuit is formed using a band pass filter and an inverting amplifier without using an external oscillator in order to drive the limit switch 100. Here, the inverting amplifier is used to change the phase difference to 0 at the resonant frequency, and the band pass filter is used to prevent the limit switch 100 from oscillating at the frequencies except for the resonant frequency.

FIG. 10A is a view illustrating a simulation result of the gain characteristic of the state variable filter. As shown therein, the center frequency is 6.02[kHz], and the bandwidth is 300, and Q is 20. FIG. 10B is a view illustrating a phase characteristic of the state variable filter. As shown therein, since the phase transit at the center frequency is 0, it does not influence the phase characteristic of the oscillation circuit. The gain characteristic of the oscillation circuit is obtained by multiplying the gain of the limit switch 100 itself with the gain of the band pass filter. FIG. 11 is a view illustrating the above result. As shown therein, the maximum output is obtained at 5.95[kHz], and the bandwidth is 190, and Q is 33.3. The frequencies having the phase difference of 180° except for the points near the resonant frequencies are all deleted. The oscillation does not occur in the water.

FIGS. 12A and 12B are views illustrating the waveforms in the air and the water by a self-oscillation of the limit switch 100 according to the present invention. As shown therein, the oscillation frequency in the air is slightly changed to 6.21[kHz] because the phase of the state variable filter is not accurately 0 at the resonant point. Since the oscillation does not occur in the water, the oscillation signal as shown in FIG. 12B is not outputted.

As described above, in the present invention, the flat panel medium having the same acoustic impedance as the object medium is used, and the limit switch is directly connected through the flat panel medium, so that the angle coincidence problems are resolved. Since the sizes of signals are high, the construction of the electronic circuit is simplified, and the fabrication process is easy. The price of the system is low. Since polyethylene is used as the flat panel medium, the impedance matching with the object medium is easily achieved. Therefore, the present invention may be well adapted to measuring the fluid level.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A system for measuring a fluid level using an acoustic impedance matching with an object medium, comprising:
a limit switch which includes:
a flat panel medium which is formed in a longitudinal direction and is designed to have an acoustic impedance matching with an object medium;
a piezoelectricity ceramic panel formed at both ends of an upper surface of the flat panel medium; and
an electrode formed on an upper surface of the piezoelectricity ceramic panel, wherein a driving unit and a receiving unit are formed at both ends of an upper surface of the flat panel medium;
a signal input unit for inputting an alternating current (AC) into the driving unit;
a signal measuring unit for measuring a signal inputted into the receiving unit as the signal inputted from the signal input unit is inputted into the driving unit and passes through the object medium; and
an oscillation circuit which returns the signal outputted from the receiving unit to the side of the driving unit.

2. The system of claim 1, wherein said flat panel medium is formed of polyethylene.
